(19) United States
(12) Patent Application Publication
(10) Pub. No.: US 2016/0069392 A1
(43) Pub. Date: Mar. 10, 2016

(54) RADIAL BEARING WITH VARIABLE LUBRICATION FLOW RESTRICTION

(71) Applicant: Schaeffler Technologies AG & Co. KG, Herzogenaurach (DE)

(72) Inventors: Marion Jack Ince, Mount Holly, NC (US); Charles Schwab, Fort Mill, SC (US); Seth Claus, Charlotte, NC (US)

(73) Assignee: SCHAEFFLER TECHNOLOGIES AG & CO. KG, Herzogenaurach (DE)

(21) Appl. No.: 14/807,031

(22) Filed: Jul. 23, 2015

Related U.S. Application Data
(60) Provisional application No. 62/048,463, filed on Sep. 10, 2014.

(51) Int. Cl. F16C 33/66; F16C 19/26

(52) U.S. Cl. CPC F16C 33/6681; F16C 19/26

(57) ABSTRACT

A bearing and bearing system includes a raceway with a first and a second radial flange, a cylindrical cage with openings placed between the first flange and the second flange, and rolling elements disposed in at least some of the openings. The cage is cut by a radial plane forming first and second circumferential edges so that in a first dynamic condition the cage has a first diameter and in a second dynamic condition the cage has a second diameter.

### INCORPORATION BY REFERENCE

The following documents are incorporated herein by reference as if fully set forth: U.S. Provisional Application No. 62/048,463, filed Sep. 10, 2014.

### FIELD OF INVENTION

Embodiments of the present invention generally relate to radial bearings, and more specifically to a radial bearing for reducing friction between moving parts, and for controlling an axial flow of lubrication fluid.

### BACKGROUND

In some radial bearing systems, it is desirable to modify an axial fluid flow through the bearing. For example, in some automotive transmissions, it may be desirable to restrict or block the flow of fluid through the bearing in one dynamic condition of the bearing, while in another dynamic condition it may be desirable to allow a fluid flow through the bearing.

Some known solutions include separate sealing components that require additional axial space and increased cost.

Accordingly, a need exists for a radial bearing with variable lubrication flow through capabilities that does not require additional axial space.

### SUMMARY

A bearing and bearing system with a cage configured to selectively open or block an axial lubrication fluid flow path, for example an oil flow path, is provided herein. A variable diameter cage may restrict or open the axial flow path through the bearing according the dynamic condition of the bearing.

In an embodiment, the bearing includes a raceway having an annular body, a first radial flange extending from a first axial portion, and a second radial flange extending from a second axial portion. A cylindrical cage including spaced apart openings formed between a first axial face and a second axial face is disposed between the first radial flange and the second radial flange, with rolling elements disposed in at least some of the openings. The cage has an axial cut from the first axial face to the second axial face between adjacent openings forming a first circumferential edge and an abutting second circumferential edge so that in a first dynamic condition the cage has a first diameter and in a second dynamic condition the cage has a second diameter.

In an embodiment, the bearing system includes a bearing comprising an outer raceway having an annular body, and first and second radially inwardly directed flanges extending from a first and a second axial portion, respectively. A cylindrical cage including openings formed between a first axial face and a second axial face is disposed between the first flange and the second flange, with rolling elements disposed in at least some of the openings. The cage has an axial cut from the first axial face to the second axial face between adjacent openings forming a first circumferential edge and an abutting second circumferential edge so that in a first dynamic condition the cage has a first diameter and in a second dynamic condition the cage has a second diameter. A shaft passes through an open center of the cage and is supported by the rolling elements so that in the first dynamic condition, the cage is in contact with the shaft so that an axial flow path is restricted, and in the second dynamic condition the cage is spaced from the shaft so that the axial flow path is opened.

In an embodiment, the bearing system includes a bearing comprising an inner raceway having an annular body, and first and second radially outwardly directed flanges extending from first and second axial portions, respectively. A cylindrical cage including openings formed between a first axial edge and a second axial edge is disposed between the first flange and the second flange, with rolling elements disposed in at least some of the openings. The cage has an axial cut from the first axial edge to the second axial edge between adjacent openings forming a first circumferential edge and an abutting second circumferential edge so that in a first dynamic condition the cage has a first diameter and in a second dynamic condition the cage has a second diameter. The bearing is disposed within a housing having an inner cylindrical wall defining a passage at least partially through the housing so that the rollers support the bearing within the passage. A shaft passes through an open center of the raceway and is supported by an inner diameter of the annular body. In the first dynamic condition, the cage is spaced from the cylinder wall so that an axial flow path is opened, and in the second dynamic condition the cage is in contact with cylinder wall so that the axial flow path is restricted.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1A is a partial axial cross sectional view of a bearing in accordance with an embodiment of the present disclosure in a first dynamic condition.

FIG. 1B is a partial transverse cross sectional view of the bearing of FIG. 1A.

FIG. 2A is a partial axial cross sectional view of the bearing of FIGS. 1A and 1B in a second dynamic condition.

FIG. 2B is a transverse cross sectional view of the bearing of FIG. 2A.

FIG. 3A is an axial cross sectional view of a bearing in accordance with an embodiment of the present disclosure in a first dynamic condition.

FIG. 3B is a transverse cross sectional view of the bearing of FIG. 3A.

FIG. 4A is an axial cross sectional view of the bearing of FIGS. 3A and 3B in a second dynamic condition.

FIG. 4B is a transverse cross sectional view of the bearing of FIG. 4A.

FIGS. 5A-5D illustrate embodiments of axial cage cuts in accordance with embodiments of the disclosure.

To facilitate understanding, identical reference numerals have been used, where possible, to designate identical elements that are common in the figures. The figures are not drawn to scale and may be simplified for clarity. It is contemplated that elements and features of one embodiment may be beneficially incorporated in other embodiments without further recitation.

While described in reference to an automotive transmission, the present invention may be modified for a variety of applications while remaining within the spirit and scope of the claimed invention, since the range of the potential applications is great, and because it is intended that the present invention be adaptable to many such variations. The present invention may be found useful in applications requiring a radial bearing with variable lubrication flow-through capabilities.

### DETAILED DESCRIPTION

Certain terminology is used in the following description for convenience only and is not limiting. The words “front,” “rear,” “upper” and “lower” designate directions in the drawings to which reference is made. The words “radially inwardly” and “radially outwardly” refer to directions radially toward and away from an axis of the part being referenced. “Axially” refers to a direction along the axis of a shaft or other part.

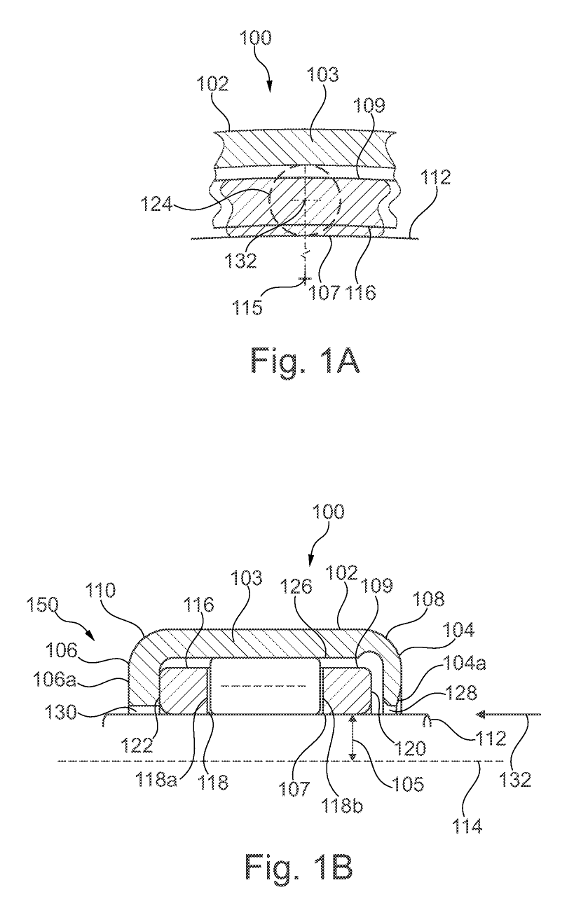

FIGS. 1A and 1B depict axial and transverse cross sectional views, respectively, of embodiments of a bearing 100 in a first dynamic condition. In the first dynamic condition as illustrated in FIGS. 1A and 1B, the bearing 100 is not rotating about its central axis as described below.

The bearing comprises a raceway 102 with an annular body 103 and a first radial flange 104 extending from a first axial portion 108 and a second radial flange 106 extending from a second axial portion 110. As illustrated, the radial flanges 104, 106 are radially inwardly directed in accordance with the present embodiment. As used herein, radially inwardly means radially towards the central axis of the bearing 100 which typically corresponds with the longitudinal axis of a shaft on which the bearing is disposed. For example, as illustrated, the shaft 112 has a longitudinal axis 114 which corresponds with the central axis 115 of the bearing 100.

The bearing comprises a hollow cylindrical cage 116 disposed between the first and second flanges 104, 106 of the raceway 102. The cage 116 includes openings 118 formed between a first axial edge 120 and a second axial edge 122. The openings 118 are spaced around the circumference of the cage 116 with a portion of the cage 116 between adjacent openings and a portion of the cage 116 between the axial edges 120, 122 and the axial ends 118a, 118b of the openings 118. Rolling elements 124, for example needle rollers, are placed in at least some of the openings 118 in contact with an inner wall 126 of the raceway 102.

The bearing 100 may be disposed concentrically on a shaft 112, forming a bearing system 150.

As illustrated, when the shaft 112 passes through the open center of the cage 116, with the cage 116 disposed in the raceway 102, the shaft is supported by the rolling elements 124 which are in rolling contact with both the inner wall 126 of the raceway 102 and the shaft 112. The rolling elements 124 are sized to support the raceway 102 so that the end 104a of the first radial flange 104 and the end 106a of the second radial flange 106 are spaced from the shaft 112.

The first gap 128 formed between the end 104a of the first radial flange 104 provides a flow or fluid path entrance, for example for an axial fluid flow indicated by arrow 132. The flow of fluid as indicated urges the cage 116 to move axially in the direction of flow to place second axial edge 122 in an abutting relationship with an inner portion of the second radial flange 106 as illustrated. A second gap 130 is formed between the end 106a of the second radial flange 106 and the shaft 112, and can provide an exit for a fluid flow, for example for the fluid flow.

In the first dynamic condition of FIGS. 1A and 1B, the cage 116 has a first inner diameter 105 which places the inner wall 107 of the cage 116 against the shaft 112. In this configuration, with second axial edge 122 of the cage 116 abutting the second flange 106 and in contact with the shaft 112, the fluid flow is restricted, or blocked, from exiting the bearing 100 through the second gap 130.

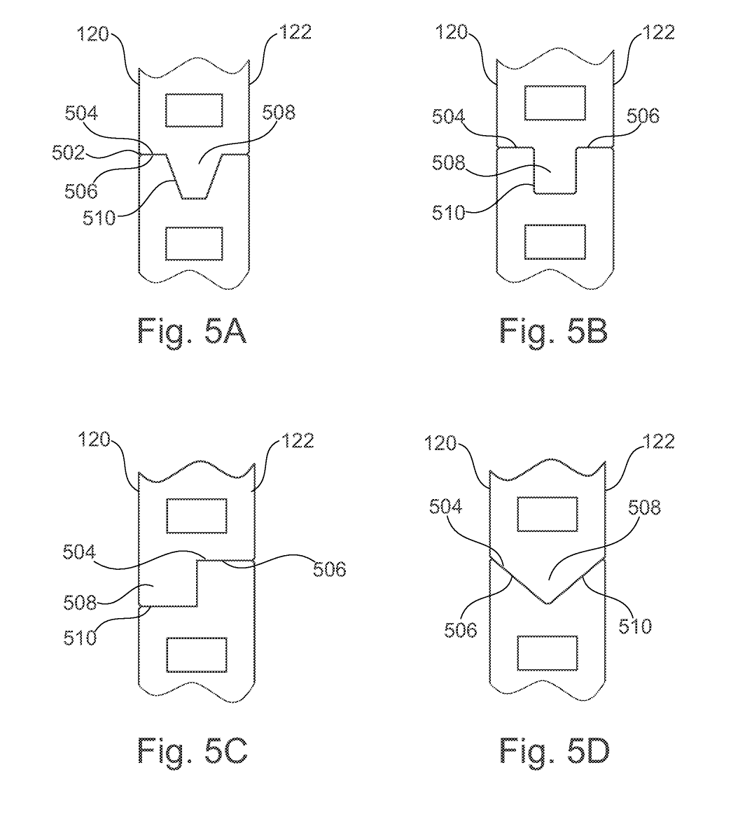

The cage 116 has an axial cut 502 at one location (FIGS. 5A-5D), with the cut 502 extending from the first axial face 120 through the second axial face 122, forming what is sometimes referred to as a “split cage.” As illustrated in FIGS. 5A-5D, the cut 502 may not be a linear cut. As illustrated, the first circumferential edge 504 is formed with one or more projections 508 and the second circumferential edge 506 is formed with a corresponding one or more recesses 510 to accept the projections 508. Each first circumferential edge 504 is illustrated with one projection 508 and each second circumferential edge 506 is illustrated with one corresponding recess 506 for ease of illustration. Each first circumferential edge 504 may have a series of projections 508 and recesses 510, and each abutting second circumferential edge may have a corresponding series of recesses 510 and projections 508. The projections and recesses on the circumferential edges may provide, among other benefits, alignment of the abutting circumferential edges.

The pattern of projections and recesses, including one projection and one recess, or a series of projections and recesses and corresponding recesses and projections, are configured to remain at least partially engaged in the first dynamic condition discussed above an in the second dynamic condition discussed below. The non-linear, tortuous flow path formed at the cut 502 by the at least partially engaged projections and recesses may at least partially obstruct or restrict a fluid flow when the circumferential edges 504 and 506 are spaced apart as described below.

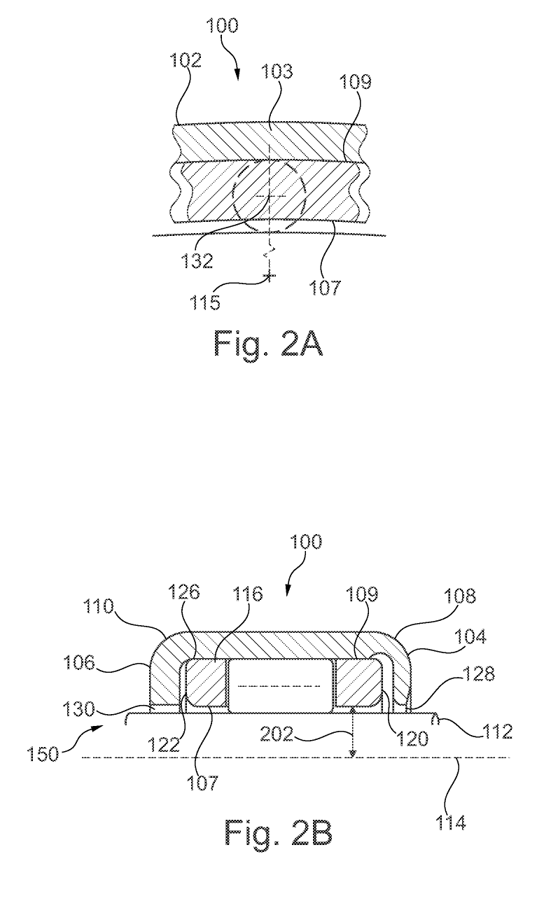

The bearing 100 is illustrated in FIGS. 2A and 2B in a second dynamic condition. In the second dynamic condition, at least the cage 116 is rotating about the central axis 115 of the bearing 100 and the rolling elements 124 are rotating about the rolling element central axis 132 in their respective openings 118 while travelling about the bearing central axis 115. When the cage 116 is rotating about the central axis 115, forces operating on the cage 116, for example centrifugal forces, urge the inner diameter 202 of the cage to expand. A continuously formed cage may resist these forces and maintain a constant, or near constant, diameter. The axial cut 502 in the disclosed cage 116 permits the first and second circumferential edges 504, 506 to circumferentially separate under the forces operating on the cage 116, allowing the inner diameter 202 to become larger. The projections 508 and recesses 510 on the circumferential edges 504, 506, respectively, are at least partially engaged and may provide alignment of the abutting circumferential edges and restrict the fluid flow through the axial cut 502.

As illustrated in FIGS. 2A, 2B, the forces generated in the second dynamic condition urge the cage 116 to expand so an outer wall 109 of the cage 116 abuts the inner wall 126 of the raceway 102. The cage 116 is moved out of the flow path, e.g. a fluid flow path, due to the forces produced in the second dynamic condition, thus opening the flow of fluid from the entrance, first gap 128, through the bearing 100 and exiting the bearing at the second gap 130.

As the rotational speed of cage 116 of FIGS. 2A and 2B slows and returns to the first dynamic condition of FIGS. 1A and 1B, the projections 508 and recesses 510 cooperate to align the circumferential edges 504, 506 and maintain the edges in a desired configuration.

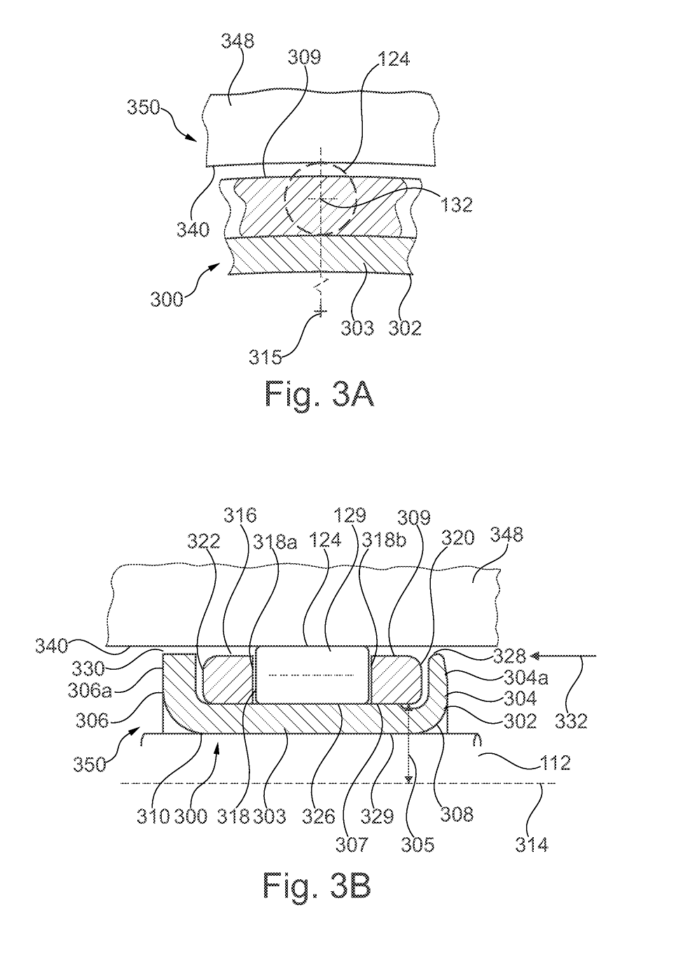

FIGS. 3A and 3B depict axial and transverse cross sectional views, respectively, of a bearing 300 in accordance with an embodiment in a first dynamic condition. In the first dynamic condition as illustrated in FIGS. 3A and 3B, the bearing 300 is not rotating about its central axis 115.

The bearing 300 comprises a raceway 302 with an annular body 303 and first radial flange 304 extending from a first axial portion 308 and a second radial flange 306 extending from a second axial portion 310 of the body 303. As illustrated, the radial flanges 304, 306 are radially outwardly directed in accordance with the present embodiment. As used herein, radially outwardly means radially away from the central axis of the bearing 300 which typically corresponds with the longitudinal axis of a shaft on which the bearing is disposed. For example, as illustrated, the shaft 312 has a longitudinal axis 314 which corresponds with the central axis 315 of the bearing 300.

The annular body 303 of the raceway 302 has an inner wall 329 defining an open center of the raceway 302.

The bearing comprises a hollow cylindrical cage 316 disposed between the first and second flanges 304, 306 of the raceway 302. The cage 316 includes openings 318 formed between a first axial edge 320 and a second axial edge 322. The openings 318 are spaced around the circumference of the cage 316 with a portion of the cage 316 between adjacent openings and a portion of the cage 316 between the axial edges 320, 322 and the axial ends 318a, 318b of the openings 318. Rolling elements 124, for example needle rollers, are placed in at least some of the openings 318 in contact with an outer wall 326 of the raceway 302.

The bearing 300 may be disposed concentrically on a shaft 112, and concentrically within a housing 348 having an inner cylindrical wall 340 defining a passage at least partially through the housing 348 forming a bearing system 350. When the bearing 300 is disposed within the housing 348, the rolling elements 124 are in contact with the inner cylindrical wall 340 and in contact with an outer wall 326 of the raceway 302.

As illustrated in FIGS. 3A and 3B, with the bearing 300 disposed within the passage in the housing 348 and the shaft 112 passing through the open center of the raceway 302, the shaft 112 is supported by the inner wall 329 of the raceway 302 which is in contact with the shaft 112. The rolling elements 124 are disposed between the outer wall 326 of the raceway 302 and the cylindrical wall 340. The rolling elements 124 are sized to support the raceway 302 so that the end 304a of the first radial flange 304 and the end 306a of the second radial flange 306 are spaced from the cylindrical wall 340. The first gap 328 formed between the end 104a of the first radial flange 304 and the cylindrical wall 340 provides an entrance for an axial fluid flow, for example an oil flow, indicated by arrow 332. A second gap 330 is formed between the end 106a of the second radial flange 106 and the cylindrical wall 340, and can provide an exit point for an axial flow, for example a fluid flow.

In the first dynamic condition of FIGS. 3A and 3B, the cage 316 has a first inner diameter 305 corresponding with the diameter of the outer wall 329 of the raceway 302. The inner wall 307 of the cage 316 abuts against the outer wall 326 of the raceway 302 and the outer wall 309 of the cage 316 is spaced apart from the cylindrical wall 340. In this configuration, the flow of fluid is open, or substantially open, and can flow from the entrance gap 328 through the bearing 300 and exit through the second gap 330.

The cage 316 has an axial cut 502 at one location (FIGS. 5A-5D) as described above. As previously described, the first circumferential edge 504 is formed with one or more projections 508 and the second circumferential edge 506 is formed with a corresponding one or more recesses 510 to accept the projections 508. The projections and recesses on the circumferential edges may provide alignment of the abutting circumferential edges. The tortuous path formed by the at least partially engaged projections and recesses may reduce the fluid flow when the circumferential edges 504 and 506 are spaced apart as described below.

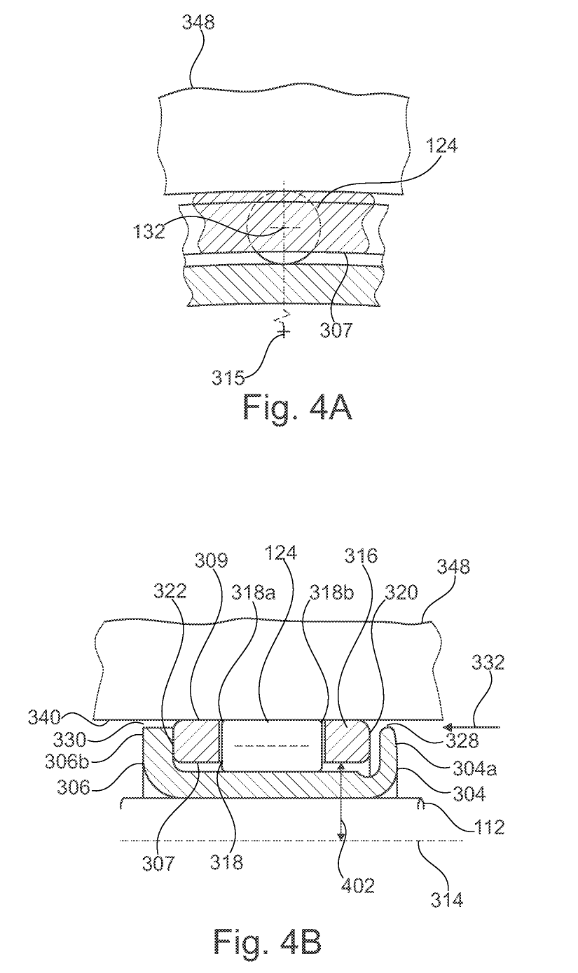

The bearing 300 is illustrated in FIGS. 4A and 4B in a second dynamic condition. In the second dynamic condition, at least the cage 316 is rotating about the central axis 315 of the bearing 300 and the rolling elements 124 are rotating about the rolling element central axis 132 in their respective openings 318 while travelling about the bearing central axis 315. When the cage 316 is rotating about the central axis 315, forces operating on the cage 316, for example centrifugal forces, urge the inner diameter 402 of the cage to expand. The axial cut 502 permits the first and second circumferential edges 504, 506 to circumferentially separate under the forces operating on the cage 316, allowing the inner diameter 402 to become larger.

As the cage 316 inner diameter 402 increases, the outer wall 309 of the cage 316 also increases and is urged into contact with the cylindrical wall 340. A fluid flow, for example a flow of oil indicated by arrow 332, axially displaces the cage 316 in the direction of flow so that the second axial edge 322 is pressed against an inner portion of the second radial flange 306 as illustrated. With the cage 316 displaced radially outward so that the outer wall 309 is in contact with the cylindrical wall 340 and the second axial edge 322 of the cage 316 displaced axially against a portion of the second radial flange 306, the flow of fluid is blocked or substantially blocked.

The projections 508 and recesses 510 on the circumferential edges 504, 506, respectively, may provide alignment of the abutting circumferential edges and restrict the flow of fluid through the axial cut 502.

Thus a radial bearing and a radial bearing system with variable lubrication flow through capabilities are provided herein. The disclosed bearing and bearing system may advantageously restrict, or substantially block a fluid flow, for example the flow of oil, through the bearing.

Having thus described the embodiments of the radial bearing and radial bearing system in detail, it is to be appreciated and will be apparent to those skilled in the art that many physical changes, only a few of which are exemplified in the detailed description, could be made without altering the inventive concepts and principles embodied therein. It is also to be appreciated that numerous embodiments incorporating only part of the disclosed embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A bearing comprising:
a raceway having an annular body, a first radial flange extending from a first axial portion, and a second radial flange extending from a second axial portion;
a cylindrical cage disposed between the first flange and the second flange, the cage including spaced apart openings formed between a first axial face and a second axial face; and
rolling elements disposed in at least some of the openings,
wherein the cage has an axial cut from the first axial face to the second axial face between adjacent openings forming a first circumferential edge and an abutting second circumferential edge so that in a first dynamic condition the cage has a first diameter and in a second dynamic condition the cage has a second diameter.

2. The bearing of claim 1 wherein the cage is stationary in the first dynamic condition and the cage is rotating about an axis of the bearing in the second dynamic condition and wherein the first diameter is smaller than the second diameter.

3. The bearing of claim 1, wherein the first circumferential edge has a projection sized and shaped to be received in a recess formed on the second circumferential edge so that a non-linear flow path is formed between the first circumferential edge and the second circumferential edge in the first dynamic condition and the second dynamic condition.

4. The bearing of claim 1, wherein the first circumferential edge has a series of projections and recesses for engaging a corresponding series of recesses and projections so that a non-linear path is formed between the first circumferential edge and the second circumferential edge in the first dynamic condition and the second dynamic condition.

5. The bearing of claim 1, wherein the raceway is an outer raceway with radially inwardly directed first and second flanges.

6. A bearing system, comprising:
the bearing of claim 5; and
a shaft passing through an open center of the cage and supported by the rolling elements,
wherein, in the first dynamic condition, the cage is in contact with the shaft so that an axial flow path is blocked, and in the second dynamic condition the cage is spaced from the shaft so that the axial flow path is opened.

7. The bearing of claim 1, wherein the raceway is an inner raceway with radially outwardly directed first and second flanges.

8. A bearing system, comprising:
a housing having an inner cylindrical wall defining a passage at least partially through the housing;
the bearing of claim 7 disposed within the passage so that the rolling elements support the bearing within the passage; and
a shaft passing through an open center of the raceway and supported by an inner diameter of the annular body,
wherein, in the first dynamic condition, the cage is spaced from the cylinder wall so that an axial flow path is opened, and in the second dynamic condition the cage is in contact with cylinder wall so that the axial flow path is blocked.
